(19) United States
(12) Patent Application Publication
(10) Pub. No.: US 2022/0258518 A1
(43) Pub. Date: Aug. 18, 2022

(54) SECURITY ELEMENT

(71) Applicant: Hueck Folien Gesellschaft m.b.H., Baumgartenberg (AT)

(72) Inventor: Stephan TRASSL, Baumgartenberg (AT)

(73) Assignee: Hueck Folien Gesellschaft m.b.H., Baumgartenberg (AT)

(21) Appl. No.: 17/624,642

(22) PCT Filed: Aug. 12, 2020
(86) PCT No.: PCT/EP2020/072573

§ 371 Date: Jan. 4, 2022

(30) Foreign Application Priority Data
Aug. 12, 2019 (EP) 19191227.8

(51) Int. Cl. B42D 25/324; B42D 25/328; B42D 25/373

(52) U.S. Cl. CPC B42D 25/324; B42D 25/373; B42D 25/328

(57) ABSTRACT

A security element for securities or security papers has an embossing with, in particular diffractive, embossed structures, wherein the embossed structures are at least partially coated with a partial, metallic layer forming a tessellated image. The embossed structures may be designed as achromatic embossed structures and may form a relief adapted to the tessellated image.

The invention relates to a security element for securities or security papers, wherein the security element has an embossing with, in particular diffractive, embossed structures.

In the present context, value documents and security papers refer to, in particular, banknotes, passports, identification cards, tickets for traveling, tickets for events, securities, etc.

Security elements of the above-mentioned type have become known in large numbers. The embossings are usually used to realize an optically identifiable security feature.

The object of the present invention is to create an embossed security element, whose protection against forgery is further improved.

This object is achieved according to the invention with the aid of a security element of the initially mentioned type in that the embossed structures are at least partially coated with a partial, metallic layer forming a tessellated image.

By means of a combination of the embossed structures with a tessellated image, an image having a three-dimensional impression perceptible by the observer can be realized, whereby the protection against forgery is increased substantially.

According to an advantageous variant of the invention, it may be provided that the embossed structures are designed as achromatic embossed structures.

It has proven particularly advantageous that the embossed structures form a relief adapted to the tessellated image. For example, the embossed structures may correspond to a three-dimensional reproduction of an image forming the basis of the tessellated image or to a motive of the tessellated image.

According to a preferred advancement of the invention, the embossed structures may form a low relief. An example for a low relief is the embossing of a coin.

In order to achieve a particularly good plastic impression of the tessellated image, it may be provided that the embossed structures are translucent.

According to an advantageous advancement of the invention, it may be provided that the security element has a carrier film made of plastic, in particular of translucent plastic.

According to a preferred variant, it is provided that the carrier film and/or the embossed structures are made of one or multiple materials selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

It has proven particularly favorable that the layer forming the tessellated image is made of at least one metallic material, in particular selected from the group of aluminum, silver, copper, gold, platinum, niobium, tin, or of nickel, titanium, vanadium, chromium, cobalt, and palladium, or alloys of these materials, in particular cobalt-nickel alloys, or of at least one highly refractive dielectric material with a refraction index of greater than 1.65, in particular selected from the group of zinc sulfide (ZnS), zinc oxide (ZnO), titanium dioxide (TiO₂), carbon (C), indium oxide (In₂O₃), indium zinc oxide (ITO), tantalum pentoxide (Ta₂O₅), ceria (CeO₂), yttrium oxide (Y₂O₃), europium oxide (Eu₂O₃), iron oxides such as, for example, (II)iron(III)oxide (Fe₃O₄) and iron oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or layers of metal oxides, such as, for example, non-stoichiometric aluminum oxide, copper oxides, or chromium oxides. These metal oxides have a specific coloration, whereby non-stoichiometric aluminum oxide, for example, appears black while copper oxides appear black or red. Alternatively, the layer may be produced from at least one metallic material made of printer inks or lacquers with metallic pigments, in particular selected from the group of aluminum, silver, copper, gold, platinum, niobium, tin, or from nickel, titanium, vanadium, chromium, cobalt, and palladium or alloys of these materials, in particular cobalt-nickel alloys, by means of established printing methods.

The tessellated image is preferably formed of image elements which have different sizes and shapes, wherein an image element is formed by a continuous surface of the layer forming the tessellated image, and wherein the layer forming the tessellated image is interrupted between two image elements.

According to a preferred variant of the invention, image elements of different sizes correspond to different mosaics of the tessellated image.

It is particularly preferred for the regions interrupting the layer forming the tessellated image to be formed by means of demetallization.

The carrier film may have a thickness of between 5 and 700 μm, preferably between 5 and 200 μm, particularly preferably between 5 and 125 μm, in particular between 10 and 75 μm.

Preferably, a layer thickness of the layer forming the tessellated image is the same in all regions which are not left blank.

For the purpose of better understanding of the invention, it will be elucidated in more detail by means of the figures below.

These show in a respectively very simplified schematic representation:

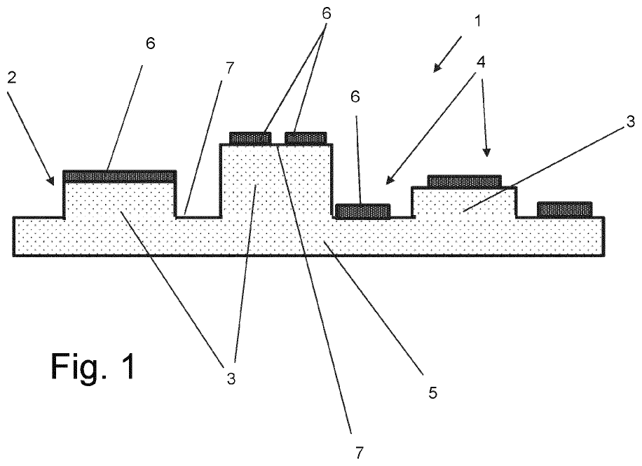

FIG. 1 a section through a security element according to the invention.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted FIGURE and in case of a change of position, these specifications of location are to be analogously transferred to the new position.

According to FIG. 1, a security element 1 according to the invention for securities or security papers has an embossing 2 with embossed structures 3. The embossed structures 3 are preferably designed as diffractive embossed structures. The embossed structures 2 are at least partially coated with a partial, metallic layer 4 forming a tessellated image. In this context, a partial layer refers to a layer which is interrupted and is hence only partially present as a closed layer.

Additionally, the embossed structures 2 may be designed as achromatic embossed structures. The embossed structures 3 may form a relief, in particular a low relief, adapted to the tessellated image. Moreover, the embossed structures 3 may be translucent.

Favorable lateral dimensions for the embossed structures are between 0.3 and 5.0 μm, particularly preferably between 0.5 and 2.0 μm.

As can further be seen in FIG. 1, the security element may have a carrier film 5 made of plastic, in particular made of translucent plastic. The embossed structures 3 may be embossed directly into the carrier film 5. However, the embossed structures 3 may alternatively also be embossed into a layer, for example an embossing lacquer layer, situated on the carrier film 5. The carrier film 5 preferably has a thickness of between 5 and 700 μm, preferably between 5 and 200 μm, particularly preferably between 5 and 125 μm, in particular between 10 and 75 μm.

The carrier film 5 and/or the embossed structures 3 may be produced from one or multiple materials selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

The layer 4 forming the tessellated image is preferably produced from at least one metallic material selected from the group of aluminum, silver, copper, gold, platinum, niobium, tin, or of nickel, titanium, vanadium, chromium, cobalt, and palladium, or alloys of these materials, in particular cobalt-nickel alloys, or of at least one highly refractive dielectric material with a refraction index of greater than 1.65, in particular selected from the group of zinc sulfide (ZnS), zinc oxide (ZnO), titanium dioxide (TiO₂), carbon (C), indium oxide (In₂O₃), indium zinc oxide (ITO), tantalum pentoxide (Ta₂O₅), ceria (CeO₂), yttrium oxide (Y₂O₃), europium oxide (Eu₂O₃), iron oxides such as, for example, (II)iron(III)oxide (Fe₃O₄) and iron oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or layers of metal oxides, such as, for example, non-stoichiometric aluminum oxide, copper oxides, or chromium oxides.

Alternatively, the layer may be produced from at least one metallic material made of printer inks or lacquers with metallic pigments, in particular selected from the group of aluminum, silver, copper, gold, platinum, niobium, tin, or from nickel, titanium, vanadium, chromium, cobalt, and palladium or alloys of these materials, in particular cobalt-nickel alloys, by means of established printing methods.

The tessellated image is formed of image elements 6 which have different sizes and shapes. In this regard, an image element 6 is formed by a continuous surface of the layer 4 forming the tessellated image Image elements 6 of different sizes correspond to different mosaics of the tessellated image.

Between two image elements 6, the layer 4 forming the tessellated image is interrupted. The regions 7 interrupting the layer 4 forming the tessellated image are preferably formed by means of demetallization. As can further be seen from FIG. 1, the layer 4 may cover the surfaces of the embossed structures 3 entirely or partially.

Particularly preferably, a layer thickness of the layer 4 is the same in all regions of the layer 4 not left blank, i.e. in the regions of the image elements 6.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Security element
2 Embossing
3 Embossed structures
4 Layer
5 Carrier film
6 Image element
7 Regions

1. A security element (1) for securities or security papers, wherein the security element (1) has an embossing (2) with, in particular diffractive, embossed structures (3), wherein the embossed structures (2) are at least partially coated with a partial, metallic layer (4) forming a tessellated image.

2. The security element according to claim 1, wherein the embossed structures (3) are designed as achromatic embossed structures.

3. The security element according to claim 1, wherein the embossed structures (3) form a relief adapted to the tessellated image.

4. The security element according to claim 1, wherein the embossed structures (3) form a low relief.

5. The security element according to claim 1, wherein the embossed structures (3) are translucent.

6. The security element according to claim 1, further comprising has a carrier film (5) made of plastic, in particular made of translucent plastic.

7. The security element according to claim 1, wherein the carrier film (5) and/or the embossed structures (3) are produced from one or multiple materials selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

8. The security element according to claim 1, wherein the layer (4) forming the tessellated image is produced from at least one metallic material selected from the group of aluminum, silver, copper, gold, platinum, niobium, tin, or of nickel, titanium, vanadium, chromium, cobalt, and palladium, or alloys of these materials, in particular cobalt-nickel alloys, or from at least one highly refractive dielectric material with a refraction index of greater than 1.65, in particular selected from the group of zinc sulfide (ZnS), zinc oxide (ZnO), titanium dioxide (TiO₂), carbon (C), indium oxide (In₂O₃), indium zinc oxide (ITO), tantalum pentoxide (Ta₂O₅), ceria (CeO₂), yttrium oxide (Y₂O₃), europium oxide (Eu₂O₃), iron oxides such as, for example, (II)iron(III)oxide (Fe₃O₄) and iron oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), highly refractive organic monomers and/or highly refractive organic polymers or layers of metal oxides, such as, for example, non-stoichiometric aluminum oxide, copper oxides, or chromium oxides and/or from at least one metallic material made of printing inks or lacquers with metallic pigments, in particular selected from the group aluminum, silver, copper, gold, platinum, niobium, tin, or from nickel, titanium, vanadium, chromium, cobalt and palladium, or alloys of these materials, in particular cobalt-nickel alloys.

9. The security element according to claim 1, wherein the tessellated image is formed of image elements (6), which have different sizes and shapes, wherein an image element (6) is formed by a continuous surface of the layer (4) forming the tessellated image, and wherein the layer (4) forming the tessellated image is interrupted between two image elements.

10. The security element according to claim 1, wherein image elements (6) of different sizes correspond to different mosaics of the tessellated image.

11. The security element according to claim 1, wherein the regions (7) interrupting the layer (4) forming the tessellated image are formed by means of demetallization.

12. The security element according to claim 1, wherein the carrier film (5) has a thickness of between 5 and 700 μm, preferably between 5 and 200 μm, particularly preferably between 5 and 125 μm, in particular between 10 and 75 μm.

13. The security element according to claim 1, wherein a layer thickness of the layer (4) forming the tessellated image is the same in all regions of the layer (4) left blank.
